(19) United States
(12) Patent Application Publication
(10) Pub. No.: US 2025/0144819 A1
(43) Pub. Date: May 8, 2025

(54) A ROBOTIC GRIPPER, A ROBOT ARM AND A ROBOT COMPRISING THE SAME

(71) Applicant: Vo Gia LOC, Hanoi (VN)

(72) Inventor: Vo Gia LOC, Hanoi (VN)

(21) Appl. No.: 18/832,685

(22) PCT Filed: Jan. 12, 2023
(86) PCT No.: PCT/VN2023/000001

§ 371 Date: Jul. 24, 2024

(30) Foreign Application Priority Data
Jan. 27, 2022 (VN) 1-2022-00641

(51) Int. Cl. B25J 15/08; B25J 9/10

(52) U.S. Cl. CPC B25J 15/08; B25J 9/106

(57) ABSTRACT

A robotic gripper, including: a frame, at least two finger units provided on the frame and grasping an object, each of the finger units includes: at least a pair of parallel linkage mechanisms, each of the parallel linkage mechanism includes a first link), a second link, a third link, a linear movable platform, and a finger frame, the mechanism that aims to move the finger frame in a straight line or a substantially straight line, and are capable of moving to either of sides with respect to the direction along the stroke of the linear movable platform, the linear movable platform including one or more slidable bearings slidable along one or more shafts, respectively, the linear sliding stroke along one or more shafts is configured so each shaft is aligned or nearly aligned to the other end of the first link located on the frame.

### CROSS REFERENCE TO RELATED APPLICATIONS

Applicant claims priority to Vietnamese Application No. 1-2022-00641, filed on 27 Jan. 2022, the disclosure of which is incorporated herein by reference.

### TECHNICAL FIELD OF THE INVENTION

The present invention relates to a gripper (grasping) used for a robot, a robotic arm, and a robot comprising the same used for automatic applications.

### BACKGROUND OF THE INVENTION

A gripper used for robots is an important field in automations, which is a part corresponding to a hand of a human arm, function of which operates directly on an object (an object to be grasped), in particular, to impact on an object to change its position, or direct an object to complete a certain task. Numerous gripper systems have been developed so far. Traditional industrial grippers are usually specialized for a certain specific task to grasp repetitively some objects in certain positions to be grasped during a long period of time. Recently, with the developments of collaborative robots, traditional grippers with simple functions, suitable for some repetitive tasks have not been appropriate because the collaborative robots need to carry out continuously variable tasks with various objects to be grasped. In addition, pneumatic grippers are not suitable for collaborative robots due to their bulky pneumatic system, high noise, dusts created during performing tasks for the collaborative robots that usually require compactness, low noise, clean and aesthetics. This leads to a high need to develop a multi-function electric gripper capable of grasping various objects with different shapes and sizes.

Patent literature 1 discloses a herringbone rack and pinion slider linear flat clip adaptive finger device. The document reveals an adaptive finger capable of compass gripping an object, and which needs the additional gears to rotate the finger to grasp the object after a translational link is contacted with the object to be grasped. This mechanism uses a rotary actuator to move the linear part.

Also, Patent document 2 reveals a flat-folding adaptive finger mechanism that is similar to Patent document 1 and uses another similar mechanism to compass gripping objects. However, attaching the actuator to the linear part makes the gripper bulky and the working range of the gripper is small, and its gripping force is limited. The size of the gripper frame which should always be larger than the one of an object to be grasped may not be suitable for actual products.

Patent document 3 discloses a self-adaptive robotic finger mechanism that grips parallel to the line of a parallel gripper using a connecting rod and a rack. However, the design according to this solution focuses on the ability to compass gripping objects and is quite complex overall.

Non-patent literature 4 discloses a compact mechanism that allows achieving straight gripper motions, by combining Scott-Russell and parallelogram mechanisms. The mechanism is capable of changing gripping/releasing when a force is applied to a part of the mechanism. However, it does not disclose joints and real links as convention grippers, its working range is very small.

### CITATIONS

Patent Literature 1: Chinese Patent Number CN106564065B
Patent Literature 2: Chinese Patent Number CN106272494B
Patent Literature 3: Chinese Patent Number CN107053220B

Non-Patent Literature 4: Article “Design and test of a compact compliant gripper using the Scott-Russell mechanism” authored by Jiaxiang Zhu & Guangbo Hao, Archives of Civil and Mechanical Engineering, Volume 20, Article number: 81 (2020)

### SUMMARY OF THE INVENTION

### Technical Problems to be Solved

A drawback of prior art gripper systems is that their fingers are only movable or pivotable in either side of vertical direction in a plane which is parallel with the vertical direction (Oy-axis (FIG. 1a, FIG. 1b, FIG. 1c). Therefore, ranges of operation of the prior art gripper systems are quite small while the dimensions of the grippers are large. Meanwhile, a collaborative robot needs to grasp a variety of objects with various shapes and sizes, for example, robots used in supermarkets and warehouse should grasp objects to be grasped, which needs a wide working range and a large grasping force. In addition, for angular grippers, the end of them does not move in a straight line during the entire gripping stroke like parallel grippers. Therefore, the gripping needs to be calculated to get a suitable gripping point. Therefore, a gripper with its ability of parallel gripping on its entire working range will bring convenience and simplicity during use. In addition, since a collaborative robot usually directly works with human, the gripper should ensure not having risks of gripping/cutting into parts of human body during operation.

Therefore, there is a need to provide a parallel gripper with a wide working range, where fingers of the gripper have abilities of operation/motion/pivotal in both sides of an axis of vertical direction in a plane which is parallel to the vertical direction (hereinafter simply referred to as side of vertical direction), and of parallel gripping on its entire working range. In addition, there is also a need to provide a gripper with a pinch point capability—an important requirement for a gripper worked with a collaborative robot during use and operation.

### Means for Solving Problems

Therefore, according to an aspect, the invention provides a robotic gripper, comprising:
a frame,
at least two finger units provided on the frame to grasp an object;
wherein each of finger units comprising:
at least one parallel linkage mechanism, wherein the parallel linkage mechanism that comprises a first link, a second link, a third link, a linear movable platform, a finger frame, the mechanism that is intended to move the finger frame in a straight line or a substantially straight line and having the capability of motion in both sides with respect to a direction along the stroke of the linear movable platform, wherein:
an end of the first link pivotally connected to a midpoint of the second link, an other end of the first link pivotally connected to a transmission system located in the frame,
an end of the second link pivotally connected to the linear movable platform, an other end of the second link pivotally connected to the finger frame,
wherein a length of the second link is twice longer than that of the first link, an end of the third link pivotally connected to the linear movable platform, an other end of the third link pivotally connected to the finger frame,
wherein the third link has the same length as the second link, and
the linear movable platform configured to provide a linear stroke, which is aligned or nearly aligned between an end of the second link located on the linear movable platform and an other end of the first link connected to the transmission system.

According to another aspect, the present invention provides a robotic arm comprising a gripper as set forth above.

According to another aspect, the present invention provides a robot comprising a gripper as set forth above, and a controller to position the gripper with respect to an object to perform desired gripping or grasping operations.

### Advantageous Effects

The present invention provides a robotic gripper with the following advantages:
Firstly, a robotic gripper according to the present invention provides a gripper with a compact size and an excellent working range compared with that of the same size existing grippers, especially fingers of the gripper are able to be operated in both sides of vertical direction (Oy-axis) that cannot or has not been overcome in the previous grippers, thus enabling grasping more various objects to be grasped.
Secondly, a gripper according to the present invention having a configuration to provide a feature of parallel gripping on its entire range allows use more easily and convenience.
Thirdly, a gripper according to the present invention ensures operations of the gripper that are not provided a possibility of gripping/cutting into parts of human body (also referred to “pinch point” issue), ensuring safety for users during use and operation.

This summary is provided to introduce simplified concepts concerning a gripper, which is further described below in the Detailed Description and Drawings. This summary is not intended to identify essential features of the claimed subject matter, nor is it intended for use in determining the scope of the claimed subject matter.

### BRIEF DESCRIPTION OF THE DRAWINGS

Detailed description of one or more aspects of the present invention is described in the document by reference to the following figures. The same reference numbers are used throughout the drawings to denote the same or similar technical features and parts:

FIGS. 1a-1c describes configurations of operation showing an illustrated parallel linkage mechanism according to the present invention;

FIGS. 2a-2b are graphs comparing a working range of an illustrated parallel linkage mechanism according to the present invention (FIG. 2b) in compared with mechanisms that are able to be operated only in one side of Oy-direction (FIG. 2a);

FIG. 3 shows a unit circle showing a relationship among a gripping force, a distance of a gripping stroke and a pivotable angle of a first link according to the present invention;

FIG. 4 shows a robot comprising a gripper assembled with a perspective arm illustrating a configuration of a gripper according to the present invention;

FIG. 5 shows an illustrated gripper comprising two finger units according to one embodiment of the present invention;

FIG. 6 shows an illustrated gripper comprising three finger units according to another embodiment of the present invention;

FIG. 7 shows partially a gripper according to the present invention with pivotable links adapted to avoid being collided and with compact sizes;

FIGS. 8a-8b are front views of a gripper showing inside of the transmission system according to an embodiment of the present invention;

FIG. 9 shows a linear movable platform according to the present invention;

FIG. 10 shows partially a finger unit comprising a linear movable platform according to another embodiment of the present invention;

FIG. 11 shows a gripper including two finger units that are independently operated according to an embodiment of the present invention;

FIGS. 12a-12d shows configurations of a gripper in various states according to the present invention;

FIG. 13 shows an illustrated gripper comprising two finger units with its members designed aiming to ensure safety feature according to the present invention;

FIGS. 14a-14b illustrate partially gripping fingers equipped with safety feature members according to an embodiment of the present invention;

FIG. 15 is an illustrated gripper including two finger units equipped with safety feature members according to an embodiment of the present invention;

FIGS. 16a-16b illustrate partially gripping fingers equipped with safety feature members according to another embodiment of the present invention;

FIGS. 16a-16b illustrates partially states of moving gripping fingers with (FIG. 16a) and without (FIG. 16b) safety feature members according to an embodiment of the present invention;

FIG. 17a-17b illustrates partially states of moving gripping fingers without safety feature members showing gaps that are able to cause unsafe when the gripper operates;

FIGS. 18a-18b illustrates partially states of moving gripping fingers with safety feature members according to another embodiment of the present invention.

### DETAILED DESCRIPTION OF THE INVENTION

The above-mentioned and other features of the various aspects according to the present invention will become apparent from the detailed description of the invention of the subject-matter described above and will be discussed in more detail below that can be implemented in any number of ways since the claimed subject matter is not limited to any particular embodiment. Examples on embodiments and applications are primarily provided for a purpose of illustration.

Herein terms are explained below aiming substantially describe the present invention and its embodiments, which do not aim for limiting the scope of the invention.

Although terms “first”, “second”, “third”, etc. used herein describe various elements, these elements are not limited to these terms. They intend to distinguish an element from another element. Therefore, elements described below may relates to second elements without departing the instructions of illustrated embodiments.

The terms “comprise”, “include”, “contain” and “consist of” as used herein refer to the existence of cited elements or steps, but do not exclude the presence or addition of one or more elements or steps.

As used herein, the terms “upper”, “lower”,” right”, “left”, “front”, “behind”, “above”, “below”, “outside”, “inside” and the terms related to locations such as “vertical”, “horizontal”, “vertical” and so on are based on directions or their relative locations illustrated in the figures and do not limit the scope of the invention in case of actual views are changed.

A working range of a gripper, which corresponds to a certain position of the gripper holder, as used herein, is a set of points to which one or more fingers of the gripper are able to be touched.

An adaptive gripper, as used herein, is the one having both capabilities of pinch grasping in a part of the working range and encompassing grasping in a part of the working range.

### Operation Principles of a Parallel Linkage Mechanism of the Present Invention

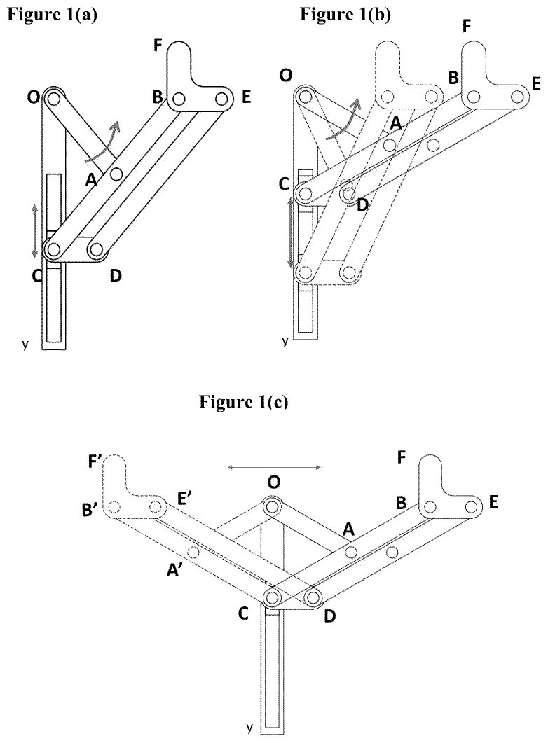

FIG. 1a, FIG. 1b, and FIG. 1c describe configurations of operation showing an illustrated parallel linkage mechanism according to the present invention used in a robotic finger. The mechanism is applied for a Scott-Russell mechanism including a link OA fixed at an end (point O) wherein an OA-link is pivotable around point O, the other end (point A) of the OA link is pivotably connected to a midpoint of an BC link. Point C of the BC link can slide linearly along the vertical direction Oy, where the length of the BC link is twice longer than that of the OA link (in other words, OA=AB=AC).

Also, the mechanism uses an additional DE link configured so that the DE link is parallel which has the same length as that of the BC link, DE and BC links are mounted to CD and BE links, respectively, in a rotatable manner (in other words, CD is parallel which has its length equal to the one of BE), wherein the CD link can slide translationally along the vertical direction Oy. The lengths of links BE and CD are not specifically limited by those of other links. The lengths of links BE and CD are selected small/minimum enough to ensure the compactness of the mechanism, the bearing capability, and links do not collide to each other during their motion.

The mechanism ensures that BF (fixed or integrally mounted to BE) (illustrated for direction and orientation of the gripping finger) moves in a straight or nearly straight line with a large stroke having a constant or nearly constant direction during its movement on both sides of the vertical direction Oy and provides a wide working range.

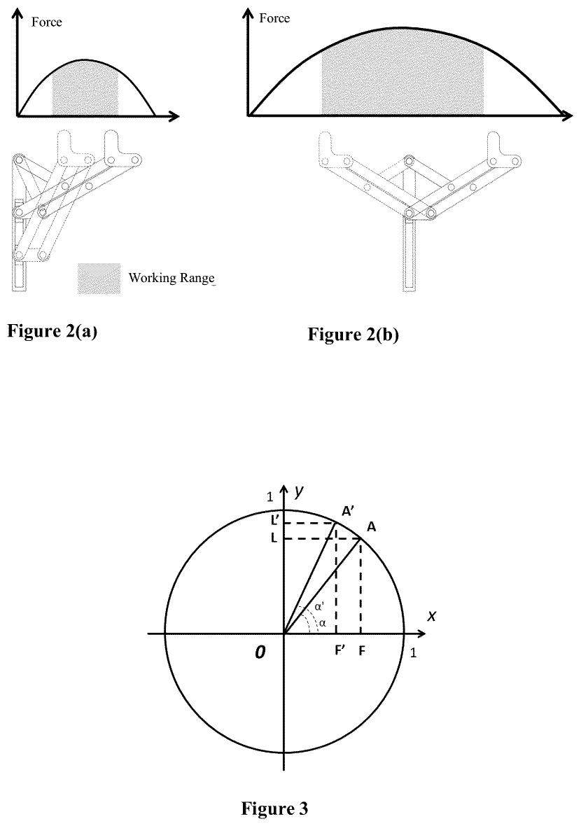

The remarkable efficiency afforded by this mechanism according to the present invention is that the parallel linkage mechanism both ensures its linear motion in a straight or nearly straight line with a constant or nearly constant direction during motion and its rotating motion around the pivotable joints (more specifically, the mechanism is capable of rotating to either sides or operate on either sides with respect to the vertical direction Oy to provide a wide working range for grippers). In particular, as shown in FIG. 1c, FIGS. 2a-2b, when the OA link is able to rotate to either side, with respect to Oy, as described above, the operating range of the present invention is more superior (the working range can be equal up to approximately 2 times in compared with the length of the BC link) than that of known mechanisms in the prior art that is capable of motion linearly in one side (in particular, the operating range in the figures represented by a bolded area is a range that a gripper's finger can reach). The performance of the gripping mechanism according to the present invention is not easily created by an ordinary skilled person in the art.

An ordinary skilled person in the art would understand that joints can be any type of joints such as a rotary joint or any other type of joints that allows rotational movement at each connection of links.

According to a preferred embodiment of the present invention, preferably, the OA link and the Oy direction creates a predetermined angle, preferably, no more than 60°, preferably no more than about 45°. Indeed, FIG. 3 illustrates a unit circle representing a relationship among a gripping force, a distance of the gripping stroke and a rotating angle of the first link according to the present invention. When an angle of rotation of the OA link with respect to the abscissa axis (Ox) is increased from α to α′, the grasping force will be decreased from position F to F′ on the abscissa axis, and the gripping distance will increase from L to L′ on the ordinate axis (Oy). When the rotating angle is greater, for example, greater than 60°, a gripping force is decreased proportionally from F to coordinate O and is decreased rapidly, while a gripping distance L increases very slowly as the rotating angle increases. When the rotating angle is greater than 60°, the gripping distance L increases very slowly and the force F decreases gradually to zero when the angle of rotation reaches 90 degrees.

### Overview on a Gripper System

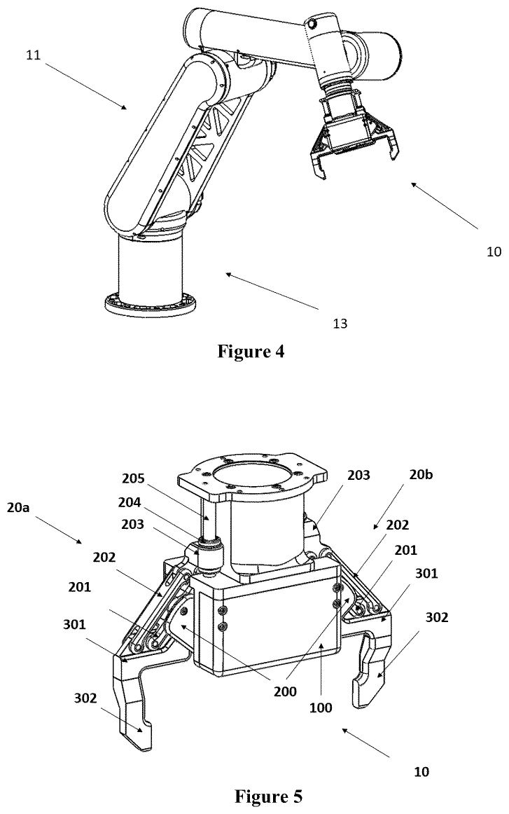

As shown in FIG. 4, a gripper 10 according to the present invention is assembled to a robotic arm 11 of a robot 13. The orientation of the gripper is changed based on the one of the robotic arm (or the robot). In the description, the direction of a gripper is considered, but not limited to, as the upper to lower direction.

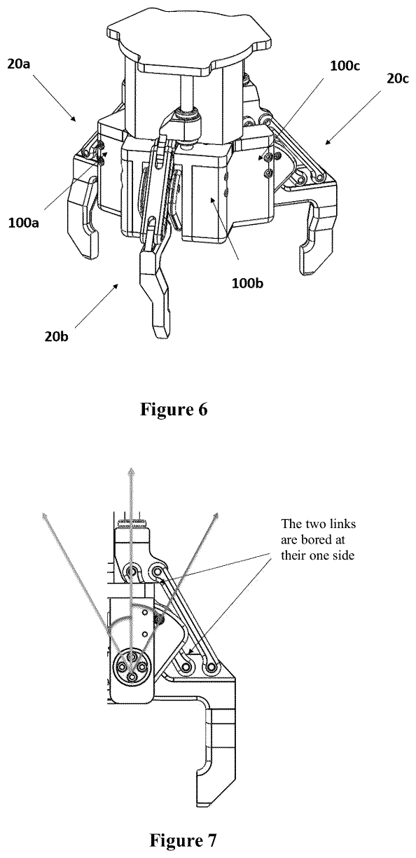

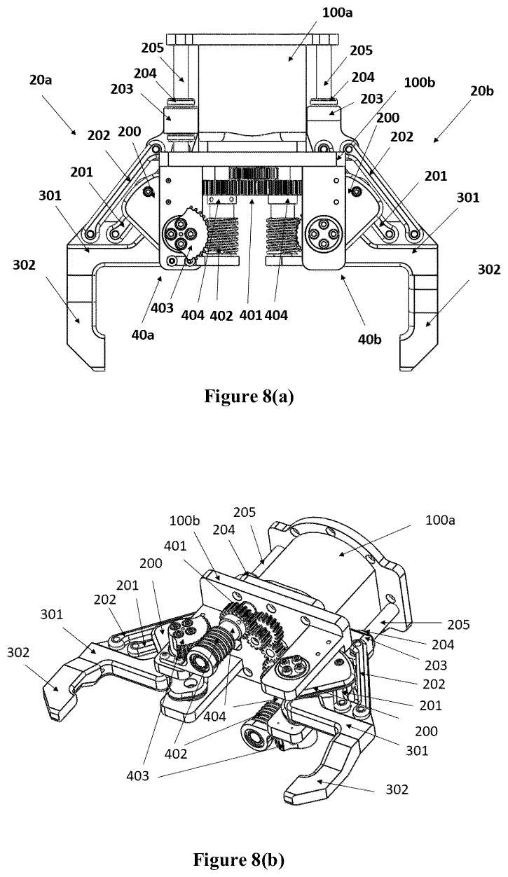

As being illustrated in FIG. 5 and FIG. 6, a gripper comprises a frame 100, at least two finger units 20 (20a, or 20b, or 20c) provided on the frame 100, a transmission system 40 (40a, 40b) (see FIG. 8a and FIG. 8b) that drives each of fingers 20, an actuator (not shown in the figures) that is provided on the frame 100 and drive the transmission system 40.

A gripper according to the present invention comprises a frame 100, at least two finger units 20 provided on the frame 100 and grasps an object.

As shown in FIG. 8a and FIG. 8b, a finger unit 20 used in the gripper according to the present invention comprises: at least one parallel linkage mechanism, wherein each of the parallel linkage mechanism comprising the first link 200, the second link 201, the third link 202, the linear movable platform 203, the finger frame 301 provided on the frame 100, the mechanism serves to move the finger frame 301 in a straight or nearly straight line and is capable of rotating to either of sides with respect to a direction along a stroke of the linear movable platform 203 to provide a wide working range of the gripper.

The parallel linkage mechanism comprises an end of the first link 200 that is pivotally connected to a midpoint of the second link 201, the other end of the first link 200 that pivotally connected to the frame 100, an end of the second link 201 that is pivotally connected to the linear movable platform 203, the other end of the second link 201 that is pivotally connected to the finger frame 301, wherein the length of the second link 201 is twice longer than the one of the first link 200, an end of the third link 202 is pivotally connected to the linear movable platform 203, an other end of the third link 202 is pivotally connected to the finger frame 301, wherein the third link 202 has its length equal to and is parallel to the second link 201.

The linear movable platform 203 is configured to move providing a linear stroke that is aligned or nearly aligned with an end of the second link 201 located on the linear movable platform, and an other end of the first link 200 that is connected to the transmission system 40, wherein a stroke that is slidable along a shaft 205 of the linear movable platform is provided by a predetermined angle between the first link 200 and a direction along with the stroke, preferably, an predetermined angle is lower than 60°, preferably about 45° with respect to either of sides of the direction along with the stroke (as shown in FIG. 7).

According to a preferred embodiment, a gripper according to the present invention may preferably comprise a pair of parallel linkage mechanisms as set forth in the operation principle. According to another embodiment, a gripper according to present invention may use a unique parallel linkage mechanism. A distance between each pair of the parallel linkage mechanisms is not limited, provided that it ensures compactness and operation of a finger unit. As shown in the figures, a particular embodiment of the present invention, a pair of the second links or a pair of the third links may, but not limited to, be integrally provided in part.

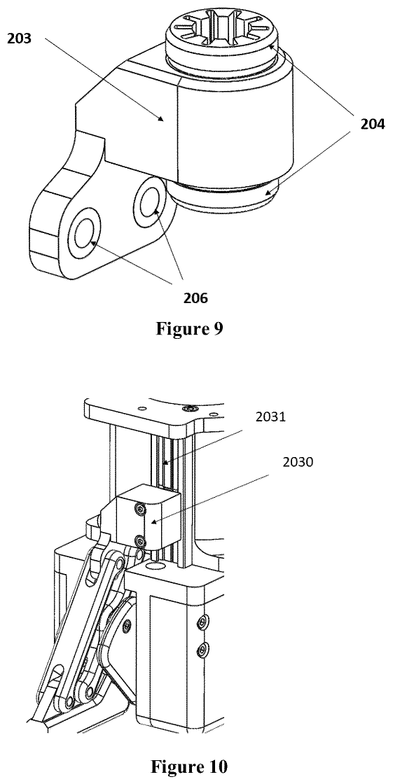

According to an embodiment, a linear movable platform 203 may comprise one or more slide bearings 204 that is able to linearly slide along one or more shafts 205, respectively, wherein a stroke that is slidable linearly along one or more shafts 205 is configured such that each shaft 205 is aligned or nearly aligned to the other end of the first link 200 that is connected to the transmission system 40 located on the frame 100. In a particular example, as shown in FIG. 9, a linear movable platform 203 comprises a slide bearing 204, a pair of holes 206 located at sides of the linear movable platform is configured to connect to the second link 201 and the third link 202 as described mentioned above. A slide bearing 204 are responsible for maintaining the linear motion of the shaft through the platform firmly.

According to another embodiment, as shown in FIG. 10, the linear movable platform is coupled with a linear moving rail system, wherein the linear moving rail system comprises a slider 2030 and a rail 2031, the slider is able to slide linearly along the rail. However, the linear movable platform is not limited to such illustrated embodiments, provided that the linear motion of the gripper according to the present invention is ensured.

According to an embodiment, the gripper according to the present invention further comprises at least one actuator that is provided in a frame 100 (not shown in the figures), and at least one transmission system 40 (40a and 40b) that is provided in a frame 100, wherein each of the transmission system is configured to drive a finger unit 20 by rotating a first link 200 by an actuator.

Preferably, each of finger units in the gripper according to the present invention may be controlled by an actuator according to the present invention. However, a gripper according to the present invention may use a unique actuator to control multiple finger units that is able to grasp an eccentric object if the object to be grasped is not horizontally fixed (while a direction that contacts the gripper is the vertical one from top to bottom). Then, an object to be grasped will be moved horizontally slightly when the gripper is closed. In practice, when the robot knows in advance a position of the object to be grasped either absolutely or relatively, the gripper is always moved to the center/basically near the center of the object to be grasped. Therefore, the gripper can only need to use one actuator to ensure simplicity and cost. An actuator as used herein is not limited to any particular type. Currently, a brushless direct current motor is commonly used in applications of grippers. In fact, the motor used may be, but not limited to, the type of brushless motors that is available commercially.

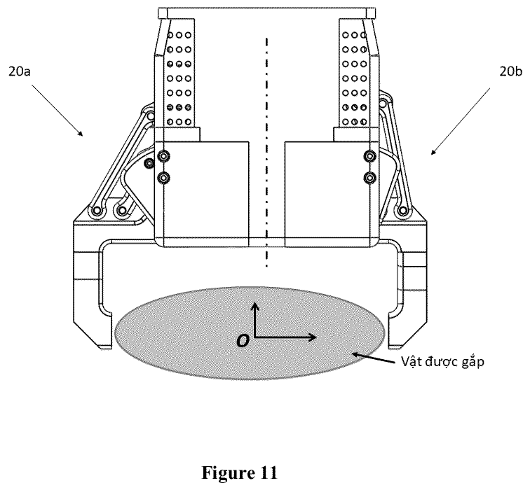

Also, in another embodiment, the gripper of the present invention includes each motor that controls the operation of one finger unit 20, preferably, each controls the operation of one finger unit 20 independently. As shown in FIG. 11, thanks to the arrangement of one motor for each finger unit, the gripper of the present invention is capable of actively grasping an eccentric object (a dashed line along a center of the gripper to clearly show an offset of the two fingers laterally controlled by different motors).

In another embodiment, as shown in FIG. 8a and FIG. 8b, the transmission systems 40 (40a, 40b) are provided in the frame 100 located in each of the finger units 20, wherein each of the transmission systems is configured to drive each of the finger units 20, respectively, by rotating the first link 200 by a motor. A transmission system 40 comprises a gear 403 that is secured to each of the other end of the first link which is located on the frame 100 as set forth above, a motor (not shown in the figures) that is connected to a spur gear 401, the gear system 401 to which the motor is attached is pivotably connected to a worm gear 402 through a shaft 404, the worm gear 402 moves/drives the gear 403, therefore, the first link 200 is moved as well. The transmission system has the ability to stay in place without turning back when the power is not applied, which gives the gripper the ability to keep the object from being fallen even in the event of electricity cut (i.e., when there is no force applied to the actuator).

According to an embodiment, each finger unit comprises a parallel linkage mechanism as set forth above, the parallel linkage mechanism is mounted to a transmission system 40 through an other end of the first link 200 by a pair of gears 403 as set forth above that is able to be symmetrically or asymmetrically arranged together. As shown in FIG. 8, a pair of gears 403 is not arranged symmetrically together (in an opposite rotation way), but the gear 403 of the transmission system 40b will be placed on the opposite side (which is masked by the frame 100b).

According to another embodiment, the gripper of the present invention further includes a finger frame 301 that can be built in a monolithic or detachable way with the fingers 302 that contains planes for grasping/gripping objects.

The finger frame 301 according to the present invention may have any shapes. The finger frame 301 may be manufactured separately or monolithically with the fingers 302. Each of the fingers 302 may have a variety of shapes and functions provided that it is required to avoid impacting on the gripper. The finger frame may be compactly manufactured or may cover gaps created between movable links of the present invention. The fact that the finger frame is equipped with an adaptive finger (which can embrace the contour of the object to be grasped) on the frame will bring about its great utility due to the combination of the adaptability of the finger and the parallel gripping capability over a very wide operating range of the invention. In the present invention, fingers can be equipped with different types of sensors to provide diverse gripping capabilities. For example, a force sensor in the finger is able to provide the robot with capabilities of grasping the object highly and delicately, of grasping fragile objects, soft objects, or objects with complex shapes.

Also, according to an embodiment of the present invention, the gripper of the present invention may be combined with an adaptive finger mechanism capable of pinch grasp or encompassing grasp, for example, a finger mechanism as disclosed in US 201001181792A1. When the adaptive finger is mounted on the finger frame 301, since the gripper of the present invention has a very wide working range, it will have both pinch grasp and encompassing grasp capabilities on a wide operating range.

In another embodiment, the gripper of the present invention further includes at least one sensor to provide position information of the object to be grasped or to provide a variety of gripping capabilities of the gripper.

A sensor of the present invention as used herein can be used to detect the position of an object to be grasped or to provide the ability of grasping and holding a variety of objects of the robotic finger. Also, a sensor may not necessarily be used in controlling grasping the object to be grasped, but a robot only needs to know a position of the object to be grasped in advance to perform the grasping task. The position of the object to be grasped can be provided in advance or calculated using a sensor. Sensors may be, but are not limited to, image sensors, position sensors, wave sensors, touch sensors, force sensors, hybrid sensors, or any similar sensors that can provide information on an object to be grasped. A sensor may be independent of a robotic gripper, which may be positioned anywhere, or installed on the gripper body depending on its purposes/applications, as long as the information on an object to be grasped can be provided.

Also shown in FIG. 7 and other figures, in each parallel linkage mechanism, a distance between the second link 201 and the third link 202 is configured to be small enough such that force applied to the second link and third link is similar, and to avoid collisions at edges of the stroke. In a non-limited example, the second link and the third link can be internally bored in one side to ensure avoiding collisions while remaining their compactness.

The gripper according to the present invention is not limited to a configuration comprising two finger units. For example, the gripper may also be configured to comprise three finger units, as shown in FIG. 6, which is arranged for grasping an object of cylindrical shape or any similar shapes. An ordinary skilled person in the art will understand that the gripper may further comprise fingers without departing the scope of the present invention.

Therefore, according to an embodiment of the present invention, the gripper comprises two or three finger units 20 provided on the frame 100 and grasping an object.

As shown in FIG. 5, according to an embodiment of the present invention, the gripper comprises two finger units 20a and 20b as above-mentioned described. Two finger units 20a and 20b may be symmetrically connected through a single frame 100 or separate frames. According to the embodiment, FIG. 8a and FIG. 8b show a gripper comprising two transmission systems 40a and 40b, wherein each of them is linked to each of finger units 20a and 20b, respectively. Each of the transmission system as set forth above comprises a spur gear 403 is linked to a worm gear 402, respectively, which is connected to a gear system 401 through a shaft 404.

FIG. 6 shows a gripper configured to comprise three finger units 20a, 20b, 20c as set forth above. Each of the finger units 20a, 20b, 20c is coupled with a respective frame (100a, 100b, 100c) and may be secured together. The finger units 20a, 20b, 20c may be arranged in an equidistantly and symmetrically spaced manner, but other layouts and arrangements are possible and not limited.

### Description of an Illustrative Gripper

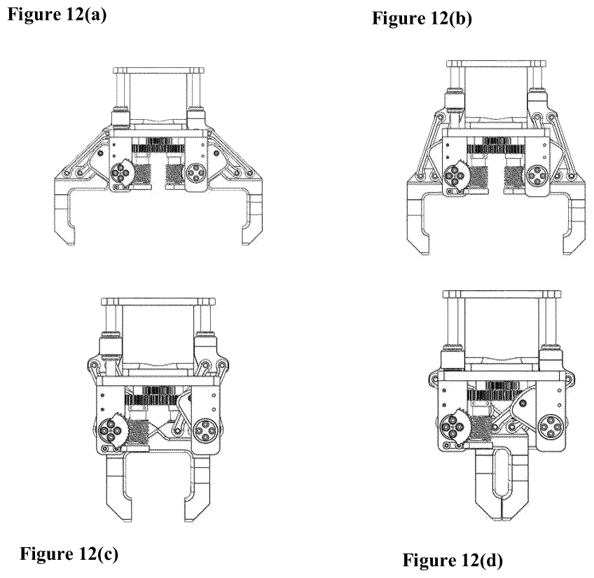

As shown in FIGS. 12a-12d, assuming that the gripper is in the most extended state, when an actuator rotates the first link 200 to be rotated inwardly through the transmission system 40 as described above. When the first link 200 is inwardly rotated, a linear movable platform 203 move linearly along a shaft 205 upwardly and move a finger frame 301 in a straight line, or a substantially straight line by means of a parallel linkage mechanism as set forth above. Then, two fingers 302 of two respective finger units 20 would move towards to each other until they come into contact with an object in order to grasp the object to be grasped.

In contrast, when an actuator rotates in reverse direction, contrary to the above process, the first link 200 rotate outwards, and two finger units 20 move away gradually from to each other to open the gripper. When the first link 200 is rotated outwardly, two finger units 20a and 20b move away from each other until reaching a fully opening state as FIG. 12a.

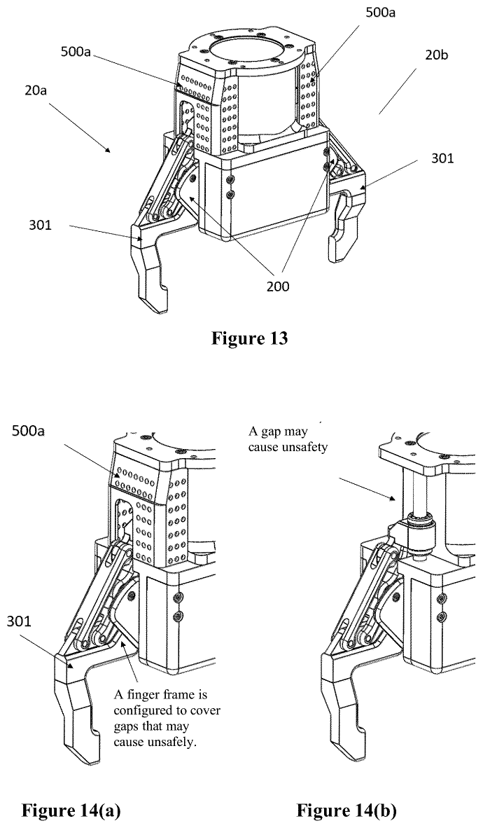

According to another embodiment, a gripper according to the present invention is equipped with members having safety features that are arranged at gaps provided among the gripper's members. Indeed, as set forth above, a gripper according to the present invention is able to provide a safety feature to avoid hazards of clamping or cut into users' body parts caused by the movement of devices/members of the gripper (also referred to Pinch Point issue), which is usually occurred in the prior art grippers. In order to resolve the problem, the present invention provides a gripper that is removed gaps provided among the gripper's members during its movement or operation. For example, as shown in FIGS. 13 and 14, a gripper according to the present invention is assembled with a safety feature member which is a protecting case 500a located at unsafe positions, the finger frame 301 and/or the first link 200 are designed so as to cover gaps provided between the first link 200 and the second link 201, i.e., the finger frame plays a role as another safety feature member. Accordingly, a protecting casing 500a helps to cover gaps provided due to the movement of the linear movable platform 203 along the shaft 205, whereas a configuration of the finger frame 301 and/or the first link 20 helps to cover gaps due to the movement of the parallel linkage mechanism as set forth above (in particular, gaps provided between the first link 200 and the second link 201).

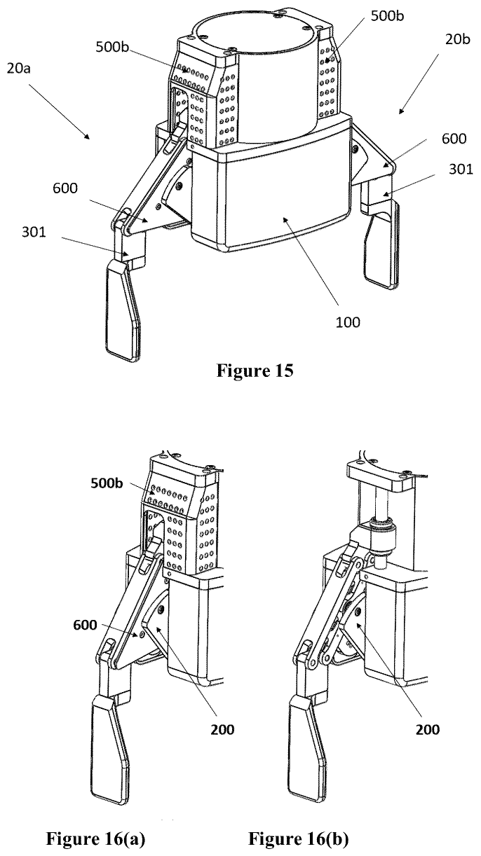

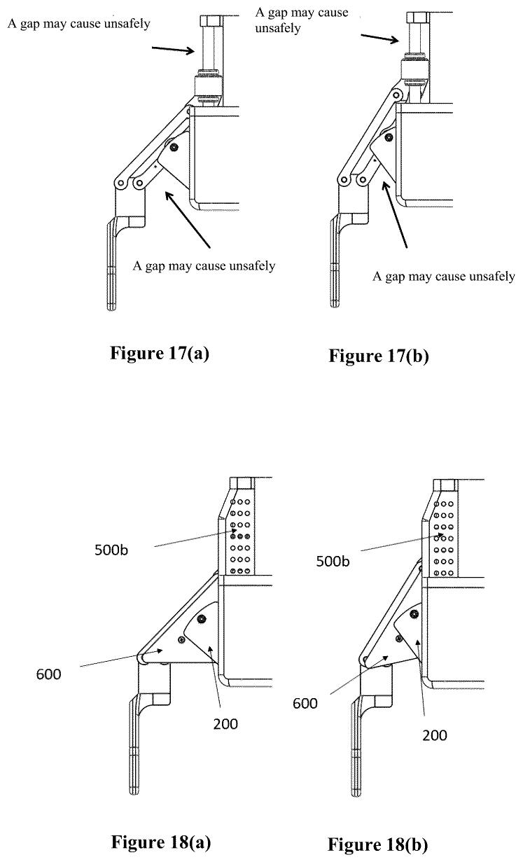

Similarly, according to another embodiment (in case the finger frame 301 produced compactly cannot cover gaps provided between the first link 200 and second link 201), as shown in FIGS. 15-18, the gripper according to the present invention is equipped with safety feature members that are protecting casings located at positions 500b and 600, respectively. For example, a protecting casing 500b helps to cover gaps provided due to the movement of the linear movable platform 203 along the shaft 205, whereas a protecting casing 600 helps to cover gaps due to the movement of the parallel linkage mechanism as set forth above (in particular, gaps provided between links 200 and 201).

Without the protecting cases or the finger frame's configuration, the gripper will provide gaps that are able to be unsafe for users when elements move against to each other due to the formation of cutting or clamping operations that is easy to hurt users.

Although the above-mentioned description are only preferred embodiments according to the present invention, and modifications and variations can be made to the present invention, it is understood that the ordinary skilled in the art may provide any modifications, equivalents, variations and so on within the scope or spirit of the invention and belonging to the claimed scope of the present invention.

1. A robotic gripper, comprising:
a frame;
at least two finger units provided on the frame to grasp an object;
wherein each of the finger units comprising at least one parallel linkage mechanism, wherein the parallel linkage mechanism comprising a first link, a second link, a third link, a linear movable platform, a finger frame, the mechanism aiming to move the finger frame in accordance with a straight line or a near straight line and capable of moving to both sides with respect to a direction along the stroke of the linear movable platform, wherein:
an end of the first link pivotally connected to a midpoint of the second link, an other end of the first link pivotally connected to a transmission system located in the frame,
an end of the second link pivotally connected to the linear movable platform, an other end of the second link pivotally connected to the finger frame,
wherein the length of the second link being twice longer than the length of the first link,
an end of the third link pivotally connected to the linear movable platform,
an other end of the third link pivotally connected to the finger frame,
wherein the third link has the same length as the second link,
the linear movable platform configured to provide a linear stroke, which is aligned or nearly aligned between an end of the second link located on the linear movable platform and an other end of the first link connected to the transmission system.

2. The gripper according to claim 1, wherein the linear stroke provided by the linear movable platform that is provided by an predetermined angle between the first link and a direction along a stroke with respect to either of sides of a vertical direction of the linear stroke.

3. The gripper according to claim 2, wherein the linear stroke provided by the linear movable platform that is provided by a predetermined angle between the first link and a direction along a stroke, wherein the predetermined angle is less than about 60 degrees, preferably less than about 45 degrees, with respect to either of sides of a vertical direction of the linear stroke.

4. The gripper according to claim 1, wherein the linear movable platform comprising one or more slidable bearings that is/are slidable along one or more shafts, respectively, wherein the linear stroke along one or more shafts is configured to be such that each of the shafts is aligned or nearly aligned to the other end of the first link located on the frame.

5. The gripper according to claim 1, wherein the linear movable platform is assembled with a linear moving rail system, wherein the linear moving rail system comprises a slider and a rail, wherein the slider is slidable along the rail.

6. The gripper according to claim 1, further comprising at least one actuator provided in the frame, which drives at least one finger unit through the transmission system.

7. The gripper according to claim 1, wherein the transmission system is provided in the frame in each of the finger units, wherein each of the transmission system is configured to drive each of the finger units by rotating the first link by an actuator.

8. The gripper according to claim 1, wherein the finger frame may be produced integrally to or detachably with the fingers that comprises planes used for grasping or gripping an object to be grasped.

9. The gripper according to claim 1, further comprising at least one sensor to provide the information on an object to be grasped, or to provide a variety of grasping capabilities of the gripper.

10. The gripper according to claim 1, wherein in each of the parallel linkage mechanisms, a distance between the second link and the third link is configured to be small enough such that forces applied to the second link and the third link are similar, and to avoid colliding together at boundaries of the stroke.

11. The gripper according to claim 1, comprising two finger units that are symmetrically connected and faced together to be able to grasp an object.

12. The gripper according to claim 1, comprising three finger units that are able to be equidistantly and symmetrically connected and to be faced together to provide the possibility of grasping an object.

13. The gripper according to claim 1, wherein the gripper is equipped with safety feature members that are arranged at unsafe gaps provided among members of the gripper.

14. The gripper according to claim 13, wherein the safety feature member is a protective casing covering gaps provided due to the movement of the linear movable platform along the shaft.

15. The gripper according to claim 13, wherein the safety feature member is a protective casing covering gaps provided between a first link and second link.

16. The gripper according to claim 13, wherein the safety feature member is a finger frame that is configured so as to cover a gap provided between a first link and a second link 201.

17. The gripper according to claim 13, wherein a safety feature member is a first link that is configured so as to cover unsafe gaps during use.

18. A robotic arm comprising the gripper in accordance with claim 1.

19. A robot comprising:
the gripper in accordance with claim 1, and
a controller to position the gripper with respect to an object to perform desired gripping or grasping operations.
